(19) United States
(12) Patent Application Publication
(10) Pub. No.: US 2012/0109936 A1
(43) Pub. Date: May 3, 2012

(54) COST-EFFECTIVE DATA LAYOUT OPTIMIZATION OVER HETEROGENEOUS STORAGE CLASSES

(75) Inventors: Ning Zhang, Cupertino, CA (US); Junichi Tatemura, Cupertino, CA (US); Vahit Hakan Hacigumus, San Jose, CA (US)

(73) Assignee: NEC LABORATORIES AMERICA, INC., Princeton, NJ (US)

(21) Appl. No.: 13/251,217

(22) Filed: Oct. 1, 2011

Related U.S. Application Data
(60) Provisional application No. 61/408,273, filed on Oct. 29, 2010.

(51) Int. Cl. G06F 17/30; G06F 7/00

(52) U.S. Cl. 707/713; 707/E17.017; 707/E17.045

(57) ABSTRACT

A data layout recommendation system for heterogeneous storages is disclosed. The system has an SSD-aware Time-based query optimizer from the database optimizer. The query optimizer can detect the interaction between the query plans and underlying data layout and dynamically update the cheapest query plan and response time of a query based on the changing data layout. The system also includes a module utilizing the query estimates from the backend to find a cost-effective data layout as well as the capacity and SLAs constrains are guaranteed.

This application claims priority to U.S. Provisional Application Ser. No. 61/408,273 filed Oct. 29, 2010, the content of which is incorporated by reference.

### BACKGROUND

The move towards cloud computing for data intensive computing presents unique opportunities and challenges for data center operators. One key challenge that data center operators face is the provisioning of resources in the data center for specific customer workloads. The I/O storage subsystems have gotten highly complicated over the last few years primarily due to the disruptive introduction of flash solid state drives (SSDs). It is common for data centers to have server systems/blades that have a rich I/O subsystem with a mixture of traditional hard disk drives (HDDs), typically in some RAID configuration, and SSDs. Since the price and performance characteristics vary widely across specific I/O devices (for HDDs and SSDs), it is not uncommon to find server configurations that have a rich I/O subsystem. For example a server box may have a RAID HDD subsystem, a high-end (fast but expensive) SSD, and a low-end (slow but inexpensive) SSD.

Data center operators have to make the decision to purchase the server boxes up-front and then provision these resources on (every changing) workload. Further, multiple different workloads may share resources on the same physical box and provisioning the workload requires taking into account physical constraints such as capacity constraints associated with the physical resources. The data center operator needs to determine resources to provision for specific workloads given the rich I/O ecosystem.

The capital cost of running database workloads has been a very important and practical concern for service providers. The Input/Output (I/O) data storage subsystems are often the most expensive components of high-end data processing systems. Whereas most research on database systems has focused on higher performance, the hidden total cost of ownership (TCO), including energy and maintenance costs, has been relatively ignored. For example, an enterprise Solid State Drive (SSD) can improve random read performance around 150× than a general Hard Disk Drive (HDD). However, the amortized TCO of the enterprise SSD can be 300× higher than HDD. Therefore, it is important to consider how to properly use heterogeneous storages for the database system to achieve both high performance and cost effectiveness.

With the advent of the SSD and its disparity in terms of IO performance and amortized TCO compared with those of HDD, it is more important to find a data layout that achieves the minimal cost of running the given workload. In practice, the workloads are usually associated with SLAs to make sure the quality of the services, and require a data layout to minimize the cost while guaranteeing the SLAs and other constraints.

### SUMMARY

In one aspect, a data layout recommendation system for heterogeneous storages is disclosed. The system has an SSD-aware Time-based query optimizer from the database optimizer. The query optimizer can detect the interaction between the query plans and underlying data layout and dynamically update the cheapest query plan and response time of a query based on the changing data layout. The system also includes a module utilizing the query estimates from the backend to find a cost-effective data layout as well as the capacity and SLAs constrains are guaranteed.

In another aspect, a method optimizes layout of database objects in a relational database management system stored on a plurality of storage classes, each characterized by a price and a storage capacity. The method includes estimating with a time-based query optimizer an execution time of a workload on a data layout for the plurality of storage classes; and recommending a data layout for the plurality of storage classes to minimize a total cost of operation (TCO) for the storage classes.

In implementations of the above aspects, given (1) the database workload of an application, and (2) choice of heterogeneous storage devices (e.g., HDD and SSD), the system finds a data layout (i.e., mapping database objects, such as tables, to storage devices) that minimizes the storage TCO (total cost of ownership) for the workload (i.e., amortized cost of storages per query/workload execution) under constraints such as storage capacity and execution performance.

Advantages of the preferred embodiment may include one or more of the following. The system quickly finds a cost-effective data layout that minimizes the cost of running a workload with the guarantee of the SLAs and capacity constraints. The system helps data center operators to determine how to provision the I/O resources for specific workloads so as to abide by existing Service Level Agreements (SLAs), while minimizing the total operating cost (TOC) of running the workload, where the TOC includes the amortized hardware costs and the run time energy costs.

### BRIEF DESCRIPTION OF THE DRAWINGS

FIG. 1 shows an exemplary I/O sub-system that requires a data layout.

FIG. 2 shows an exemplary system to optimize layout of database objects on storage devices with a minimum total cost of operation (TCO).

FIG. 3 shows another exemplary system to optimize layout of database objects on storage devices with a minimum TCO.

FIG. 4 shows an exemplary data layout on heterogeneous data storage devices.

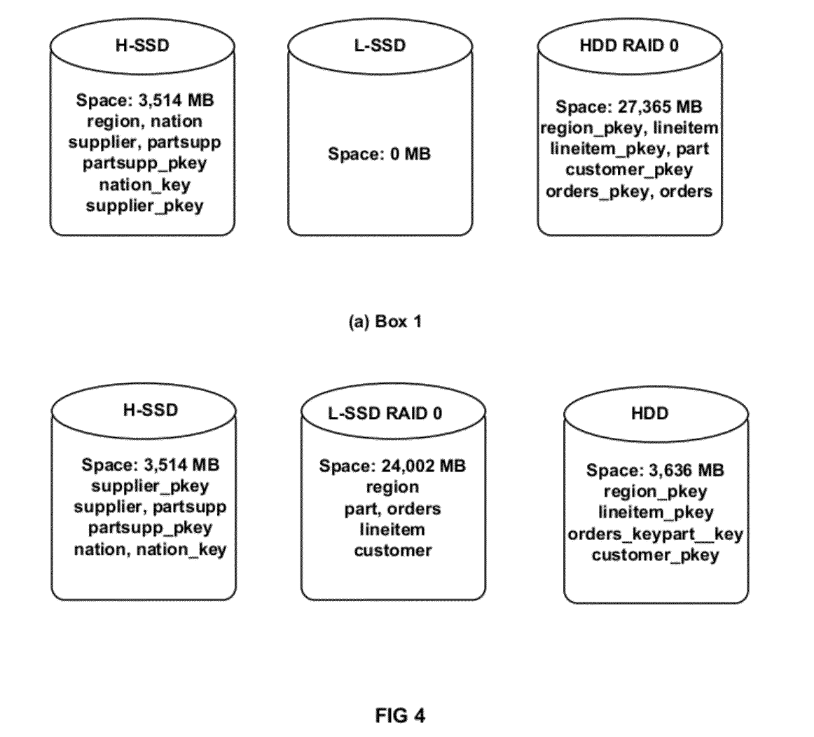

FIG. 5 shows an exemplary computer to perform data layout operations.

### DESCRIPTION

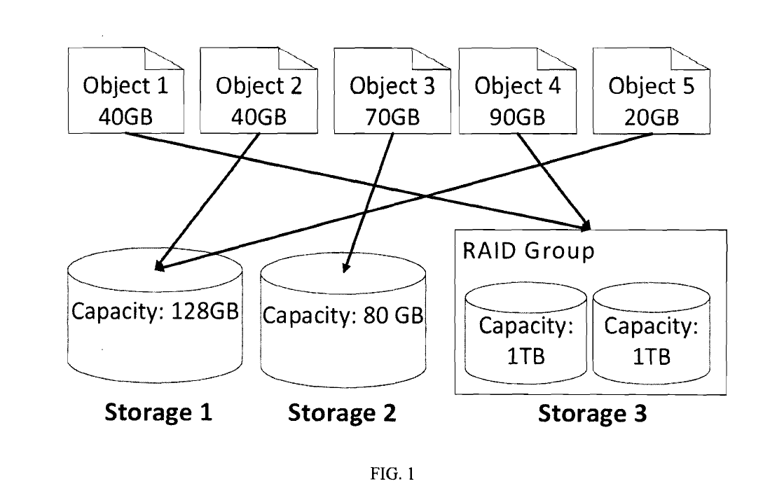

FIG. 1 shows an exemplary I/O sub-system that requires a data layout. In this system, a data center operator has servers with rich I/O sub-systems, and has to run workloads on their servers. Service Level Agreements (SLAs) between the data center provider and the customer provide a contract in terms of what the customer can expect. Typical SLAs have aspects that describe characteristics such as expected performance and expected data. Given the SLA, the goal of the data center provider is to provision enough resources to meet the SLA and to minimize the total operating cost and maximize profit. Hence, the objective is to minimize the total operation cost (TOO).

The TOO can include the amortized the hardware cost (incurred during an initial purchase and amortized over an expected lifespan of that hardware) and the run-time energy costs incurred in powering that hardware when running the workload. Heterogeneous I/O hardware can have a significant impact on the TOO. Different I/O device have different initial cost/storage, performance, and run-time energy costs. SSDs generally run cooler than HDDs (the energy savings is often an order of magnitude more with SSDs), but cost more (often more than 10× for the same storage). SSDs have far better Random I/O performance. However the sequential I/O performance of SSDs is comparable to HDDs (which are often in RAID configuration), or could be lower than the sequential performance of HDDs for the same cost. The provisioning of the I/O storage subsystem to minimize the TOO is an optimization problem that considers the range of I/O hardware that is available, examines the capacity constraints for each workload and available device, and the performance characteristics of the workload and the I/O device, to compute a data placement that minimized the TOO, while meeting the SLA.

Turning to FIG. 1, the I/O sub-system includes storage 1, 2 and 3. In one embodiment, storage 1 is a high performance SSD system, storage 2 is a low performance SSD system with a performance lower than that of storage 1 but higher than that of storage 3, and with a price between storage 2 and storage 3, and storage 3 is an HDD system with the lowest performance and cost.

Given an application with significant database workloads, an IT administrator needs to build a database system that consists of storage devices. The question is how to choose storage devices and how to allocate data to them. Although it is known that a high-end SSD performs much better than HDD, the administrator is not sure if it pays off in terms of the cost. The administrator wants to achieve better cost-performance while the performance (e.g., response time) meets given requirements.

In order to consider cost-performance in a quantitative manner, a concept of cost per query (or cost per workload task) is used. Here, the cost of a storage device mainly consists of the initial purchase cost and the energy cost of continuously running workloads. This cost should be distributed and charged on each query (or each workload task). The intuition under the cost per query is following: although upgrading storage increases the total cost, it can be beneficial if it yields higher throughput (i.e., charge for each query becomes smaller). The cost (price) model can be arbitrarily complex depending on the actual situation. The advent of cloud computing might deliver a standard model of infrastructure pricing in the future.

In one embodiment, a relatively simple model is used with D={d1, . . . , dM} as a set of available storage classes where the price of dj is denoted by pj (P={p1, . . . , pM}). The cost can be defined as follows:

Storage price (cent/GB/hour): For each storage class (e.g., HDD or SSD), an amortized cost is calculated and charged by space and time (dollar/GB/hour).

Layout cost (cent/hour): Assume that a database is laid out on D, taking Sj GB space for each class dj (Sj≧0) (let L denote this particular layout). Then, the cost per hour for the database for a layout L is given as C(L)=Σ_{dεD}pⱼ**sⱼ.

Workload cost (cent/task): Assume that the database with layout L achieves a throughput T(L,W) (task/hour) for a given workload W. Then the workload cost is defined as C(L,W)=C(L)/T (L,W). For the I/O system of FIG. 1, the system determines a layout L over D that minimizes C(L,W) for a given workload W under the price model P={pj}. The storage system provides M different classes of storage D={d1, . . . , dM}. A storage could be an individual disk, or a RAID group, where cj denotes the capacity of storage dj.

In the system, a database instance is given as a set of database objects O={o1, . . . , oN}, each of which must be placed on one of the storage classes in D. The database objects could be tables, indexes, logs and temporary spaces, and si denotes the size of the data object oi. A data layout L is given as a map O to D, where L(o) is a storage class in D where object o is laid out. Let Oj denote a set of objects laid out on dj, i.e., Oj={o|L(o)=dj, oεO}. A valid data layout must conform to the capacity constraint of each storage.

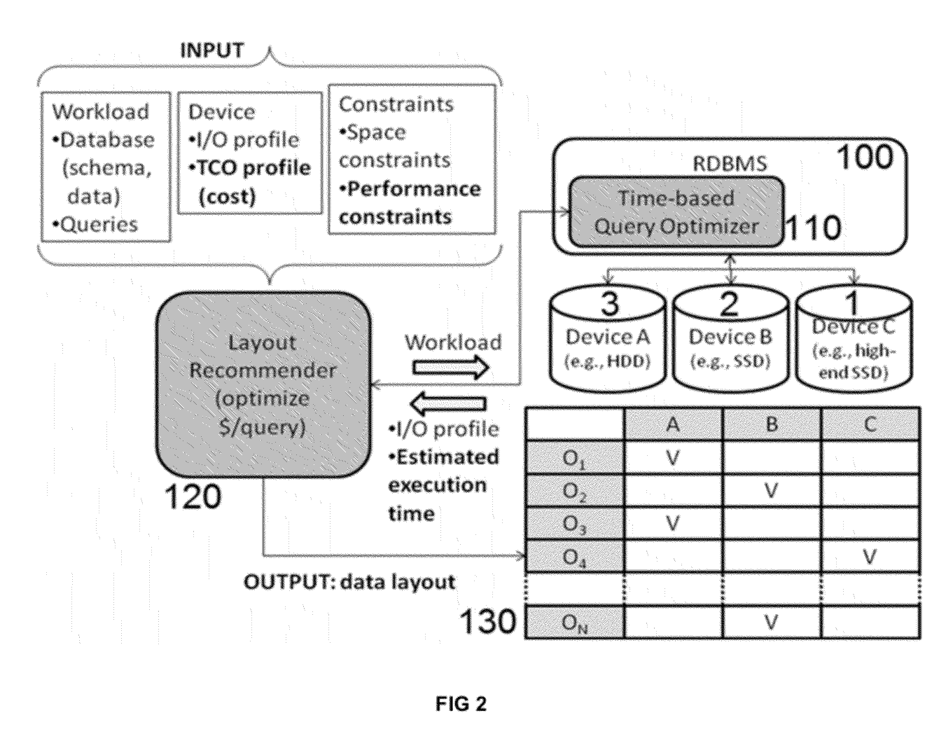

FIG. 2 shows an exemplary system to optimize layout of database objects on storage devices with a minimum total cost of ownership (TCO). The TCO is a key concern for application service providers (or enterprise IT divisions) who need to support application services with minimum running cost. For example, SSDs (Solid State Devices) are being adopted in place of HDDs for better performance. However, the big concern is the TCO: will the investment on SSD pay off for a given application? The system of FIG. 2, embodied as an advisor tool for a database administrator or DBA, can optimize the storage efficiency in terms of cost per query (or cost per workload) by recommending appropriate data layout on heterogeneous storages.

The system of FIG. 2 can be used in a data center (DC) with a cluster of servers each with a rich I/O subsystem on which a set of customer workloads must be provisioned. Service Level Agreements (SLAs) between the DC provider and the customers provide a contract in terms of what each customer can expect. Typical SLAs describe characteristics such as expected performance and expected data availability. Given the SLAs, the goal of the DC provider is to provision enough resources to meet the SLAs, while minimizing the total operating cost, so as to maximize their profit. The system of FIG. 2 minimizes the total operating cost (TOC), which can include the amortized hardware cost (incurred during the initial purchase and amortized over the expected lifespan of that hardware), and the run-time energy costs incurred in powering that hardware when running the workload. The provisioning of the I/O storage subsystem to minimize the TOC is an optimization problem that considers the range of available I/O devices, examines the capacity constraints for each device, and the performance characteristics of each workload and the I/O devices, to compute a data layout that minimizes the TOC, while meeting the SLAs.

The system works with a relational database management system (RDBMS) 100 which includes a time-based query optimizer 110 that estimates the execution time of a given query on a given data layout on storage devices. The RDBMS 100 stores data on a heterogeneous I/O sub-system of FIG. 1 with devices 1, 2 and 3.

A layout recommender 120 estimates the TCO for a workload or query on a predetermined data layout using the time-based query optimizer 110 and determines a data layout 130 that minimizes the TCO. The layout recommender 120 takes as inputs the workload which includes the database information such as the schema and data. The inputs also include the queries to be run on the RDBMS 100. The layout recommender 120 also receives device characteristics such as I/O profiles and TCO cost profiles. The layout recommender 120 also receives constraints such as space constraints and performance constraints. These constraints may be specified in the SLA. Based on the workload and I/O profiles and estimate execution time, the layout recommender 120 can determine the data layout 130.

The system utilizes the time-based query optimizer 110 within a layout optimization process run by the layout recommender 120. Given a specific layout 130, the query optimizer 110 not only generates an execution plan but also estimates the execution time for a given query. The layout recommender 120 makes use of this information to estimate the TCO of a specific data layout given the TCO ($/GB/hour) of each device.

In the above system, the workload characteristics can be represented by an execution trace of the query workload. The trace is referred to as a task (a unit of the workload in consideration), and the system measures the task execution time. The workload W is represented as a set of query sequences, {[q₁¹, . . . , qₙ¹], . . . , [q₁^{c}, . . . , qₙ^{c}]}, where each qᵢ^{j} is a database query, and c denotes the concurrency of the workload W. Let t(L,W) be the execution time of W under layout L. Then, the workload cost (TOC) is C(L,W)=C(L)*t(L,W). The model assumes that there are performance related SLA constraints associated with the queries (so there is some limit on the query performance degradation that can be tolerated). These performance constraints T can be modeled as the upper bound of each query execution time, T={tᵢ^{j}}, where tᵢ^{j} is the response time cap for query qᵢ^{j}. While the framework above uses query response time as the performance metric, this framework can be adapted to consider other performance metrics, such as throughput rate. In fact, one embodiment uses response time constraints for individual queries for the TPC-H DSS workload, and use throughput constraints for the TPC-C OLTP workload.

The system of FIG. 2 receives as inputs the following: (1) Database objects O={o₁, . . . , o_{N}}, (2) Storage classes D={d₁, . . . , d_{M}} with price (TOC/GB/hour) P={p₁, . . . , p_{M}} and capacity C={c₁, . . . , c_{M}}, (3) Query workload W={[q₁¹, . . . , qₙ¹], . . . , [q₁^{c}, . . . , qₙ^{c}]} with performance constraints T={tᵢ^{j}}. The system recomments a data layout L:O→D that minimizes the TOC C(L,W)=C(L)*t(L,W) for a given W where

C(L)=p₁*(Σₒ_{ᵢ}_{εO}_{₁}sᵢ)+ . . . +p_{M}*(Σₒ_{ᵢ}_{εO}_{_{M}}sᵢ)

under the capacity constraints, Σₒ_{ᵢ}_{εO}_{ⱼ}sᵢ<cⱼ (j=1, . . . , M), and performance constraints T={tᵢ^{j}}.

The system uniquely takes the TCO profile as Input and interacts with the time-based query optimizer that returns estimated execution time. The system also optimizes the layout 130 in terms of $/query rather than performance alone. The recommender 120 can then recommend an optimal data layout over heterogeneous storage devices.

Incorporating the TCO cost into the data layout is not trivial for two reasons. First, the best execution plan of the same query depends on storage layout (e.g., when data is stored on SSD, a Nested-Loop-Join (NLJ) algorithm may perform better than Hash-Join (HJ) algorithm). Therefore, the layout recommender 120 needs to interact with the query optimizer 110 that is aware of the storage profiles. In contrast, conventional systems do not consider such difference in execution plan on different layouts. Moreover, the query optimizer should output the estimated execution time as well as the execution plan in order to let the layout optimizer estimate the TCO cost of the workload.

Conventional systems do not address this problem exactly. Instead, the traditional data layout optimizers/advisers try to optimize performance (throughput/response time) given a specific hardware configuration. Further, the TCO has been considered in more general context of data centers. Usually, the main consideration is capacity planning at a coarser-grain level (e.g., how many servers are provisioned).

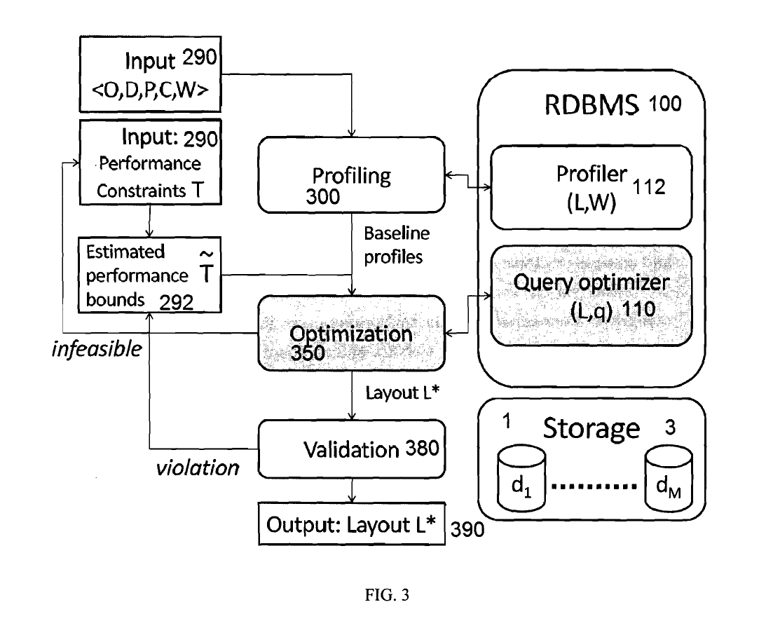

The system of FIG. 3 includes a RDBMS 100 with a profiler 112 and the query optimizer 110. The RDBMS 100 communicates with data stored in storage devices 1-3. In one embodiment, the system is implemented through careful modifications to a DBMS query optimizer 110 and various cost estimation modules to consider the cost, speed, and capacity of various storage devices. The system exploits the ability of most modern DBMS to spit out query plans (without actually executing the plan) which are then fed to a new total operating TOO optimizing module. The TOO optimizing module uses heuristic algorithms to recommend a desirable data placement.

One solution to optimizing the data layout is to explore all possible layouts and validate the performance for each layout candidate. However, this approach is computationally expensive. Instead of measuring performance for each layout, one embodiment uses a limited number of baseline layouts to acquire profiles and relies on performance estimation for other layouts that appear during exploration. FIG. 3 illustrates the outline of a layout optimization process, which consists of three phases: profiling 300, optimization 350, and validation 380, to arrive at an optimized data layout 390.

The system of FIG. 3 starts with a profiling phase 300 by characterizing the workloads on certain baseline layouts, L₁, . . . , Lₖ, to generate a number of workload profiles that are then used in an optimization phase 350. Briefly, a workload profile models the I/O behavior of the workload when it runs on a baseline layout (e.g. for the query select count(*) from Aᵢ where id>A and id<B, it estimates how many random and sequential read I/Os are incurred on the table Aᵢ when the table Aᵢ and its indices are placed using some specific layout.)

Then, in the optimization phase 350, an heuristic approach uses of the workload profiles and the workload performance estimates from an extended DBMS query optimizer to explore the space of possible data layouts. This optimization phase outputs an recommended layout L* that satisfies all the constraints. The extended DBMS query optimizer has a new cost estimation module that considers the different I/O speeds of storage devices to give more precise estimates.

The (heuristic) method used in the optimization phase is not guaranteed to output a feasible layout, and rather than returning a recommended layout, it may return an answer marked as “infeasible,” which may mean that the process missed a feasible layout that exists (i.e., false negative), or that there is no feasible layout since the performance constraints are too strict. In either case, the performance constraints must be relaxed in order to compute a layout. The third phase, namely the validation phase 380, checks if the recommended layout really confirms to the performance constraints through a test run of the workloads on the recommended layout. If the test run “fails”, then the system goes to the refinement phase. This refinement phase uses real runtime statistics (such as the actual numbers of I/O incurred in the test run, buffer usage statistics, etc.), and uses those as the input (instead of going to the profiling phase) to redo the optimization phase. In the interest of space, we do not discuss the refinement phase in detail in this paper.

The pseudocode for the heuristic optimization module in DOT is discussed next. This procedure enumerates the layout candidates and returns the layout, L*, that has the minimum estimated TOC (i.e., C(W,L)) amongst all the candidates. The challenge here is how to enumerate a promising subset of the possible layouts.

Procedure 1 Optimization Phase of DOT

```
Input:DOT input < O, D, P, C, W, T >, workload profile X
Output:Layout L*
  L [symbol]  Lo, L* [symbol]   L
  c* [symbol]   estimateTOC(W, L)
  Δ [symbol]   eramerateMoves(O, D, P, X)
  for i = 0 [symbol]  |Δ| do
    m [symbol]   Δ[i], L_{new} [symbol]   m(L)
    (c, T′) [symbol]   estimateTOC(W, L_{new})
    if feasible({L_{new}, C}, {T′, T}) then
      L [symbol]   L_{new}
      if c < c* then
        L* [symbol]   L, c* [symbol]   c
      end if
    end if
  end for
```

Procedure 2 enumerateMoves: Enumeration of moves

```
Input:< O, D, P, X >
Output:a list of moves Δ
  G [symbol]   grouping(O), Δ [symbol]   φ, Σ [symbol] φ
  for all g ∈ G do
    for all p ∈ D|g| do
      m [symbol]   move(g, p)
      s [symbol]   score(m, X, D, P)
      Δ [symbol]   append(Δ, m), Σ [symbol]   append(Σ, s)
    end for
  end for
  Δ [symbol]   sort(Δ, Σ)
```

In one embodiment, the approach is to (1) start from a layout L₀ that places all the objects on the most expensive storage class (say, d₁) and (2) gradually move objects from d₁ to other less expensive storage classes as long as the new layout L_{new} and its estimated performance T′ satisfies the capacity constraints C and the SLA constraints T (checked by procedure feasible in the pseudocode). Notice that, in our approach, the move candidates, Δ, are generated only once at the beginning of the procedure and are applied one by one, yielding |Δ| layouts to be investigated.

The key component of this procedure is to generate Δ, a sequence of object moves. For each iteration, a move m in Δ is applied to a layout L, resulting in a new layout m(L). Here, as a heuristic, we want to apply a more beneficial move (i.e., larger TOC reduction) earlier. The sub-procedure enumerateMoves should generate move candidates in such a promising order to assign a priority score for each move. This function considers the impact of a move that comprises of a layout cost reduction and a workload performance penalty. The performance penalty is estimated based on the estimated I/O time over the objects. After sorting the move candidates in terms of their priority scores, the system applies them in sequence to generate new candidate layouts.

A simple method to generate a set of move candidates is to move an object oεO to a storage class sεD one by one. In this case, the sub-procedure enumerateMoves would generate M moves for each object. By applying the moves one by one, DOT would investigate O(MN) layouts. However, this approach has a serious limitation as it ignores the interactions between the objects. A notable example of such interaction between objects is seen between a table and its index: Assume that a table has an index (e.g. B+ tree) on its primary key, and a query wants to retrieve records in a given range on its primary key (e.g., select * from table A where A.id>10 and A.id<1000). Now consider a placement of the index on either an SSD or a HDD, and the following question: What is difference in terms of performance of the given workload for these two different placements of index? The answer to this question depends on where the table is placed. For instance, when the table is on the HDD, the query planner may choose to only use a sequential scan on the table to execute the query. In this case, the placement of the index has no impact to the I/O cost since it is not accessed at all. However, if the table is placed on the SSD, placing the index on the SSD may let the query planner choose an index scan to access both table and index for greater performance by leveraging the SSD's faster random I/O speed. Thus, the interaction between objects, e.g. a table and its index, should be considered.

One embodiment of the heuristic approach puts objects into groups, referred to as object groups, and consider interaction only within a group: a table and its indices are put in a group and all the combinations of their placements on different storage classes are considered. For example, in the case of a table with one index, and only two devices—an HDD and an SSD—the system considers (1) placing both the table and its index on the HDD device; (2) placing the table on the SSD device and the index on the HDD device; (3) placing the table on an HDD device and the index on the SSD device, and (4) placing both the table and its index on SSD device.

For Object Groups, the system divides the database objects in O into object groups so that interactions between objects in a group is higher for objects within a group than objects in different groups. Any performance gain (or loss) due to a move (from one storage class to another) is expected to be independent between objects in different groups. If a group of objects as a vector g=(o¹, . . . , o^{K}). Then, the placement of a group can also be represented as a vector p=(d¹, . . . , d^{K})εD^{K}. The number of possible placements of a group is O(M^{K}), where K is the size of the group.

The move of a group g to p is denoted as m(g,p). As shown in Procedure 3.1, enumerateMoves considers all the possible moves m(g,p). The size of Δ is thus O(GM^{K}) where G is the number of groups and K is the size of a group (N=GK).

A priority score s for a move m is calculated using workload profile X and storage information (D,P). The priority score is derived from two components: performance penalty and layout cost saving.

First, a performance penalty measure is used to estimate the impact of a move m relative to the workload performance. The performance penalty is described using a term called the I/O time share, which is the accumulated I/O time over objects o in g.

One embodiment uses the following four types of I/Os to model the typical DBMS query I/O access pattern: sequential read (SR), random read (RR), sequential write (SW) and random write (RW). Now, let R denote the set of these I/O types. The system receives as input the time of one I/O operation τᵣ^{d} for each type rεR and storage dεD. From this information, the system can estimate the accumulated number of I/O operations on o.

The profiling phase data is used to estimate the number of I/O operations for each object. Since the number of I/O operations on a specific object can be very different depending on the placement of not only this object but also other objects in the same group, the system estimates χᵣ^{p}[o] the number of I/O of type r on o when the group g is placed in a specific placement p.

Based on the workload profiles X={χᵣ^{p}[o]}, the system estimates the I/O time share of an object group g when it is placed in p:

$${T}^{p} [ g ] = {\sum }_{o ∈ g}^{ } {\sum }_{r ∈ R}^{ } {χ}_{r}^{p} [ o ] * {τ}_{r}^{p [ o ]}$$

Here, p[o] is the storage class assigned by the placement p for the object o.

Then, the performance penalty of a move m(g,p) from the initial layout can be defined as follows:

δₜᵢₘₑ[m]=T^{p}[g]−T⁰[g]

Now consider the component the layout cost saving, which estimates the impact of a move m on the layout cost C(L). Let m(L) be the layout given by applying m to L. Then, the cost saving of a move m is:

δ_{cost}[m]=C(L₀)−C(m(L₀))

Finally, the priority score of a move m, denoted as σ[m], is defined by considering both the performance penalty and the layout cost saving, and is calculated as:

σ[m]=δₜᵢₘₑ[m]/δ_{cost}[m]

The profiling phase measures the I/O behavior of the workload when an object group g is laid out using the placement p. This phase produces several workload profiles, where each profile corresponds to a specific placement. As discussed above, the placement p of an object group can impact the optimizer's choice of query plans, resulting in very different I/O costs/profiles. Thus, the system considers object interactions by enumerating all possible placements of an object group.

A lightweight method to enumerate all possible placements of the object groups is to use a small set of layouts, referred as baseline layouts. For instance, consider a case where each table has only one index on the primary key. Then a set of object groups of size 2 (i.e., K=2) is selected. For each group, I/O profiles for all the M² placement patterns are measured with the M² baseline layouts {L_{(i,j)}:1≦i,j≦M} defined as follows: L_{(i,j)} places all the tables on dᵢ and all the indices on dⱼ. That is, each group object has the same placement p, where p=(dᵢ,dⱼ).

A workload profile on a baseline layout, Lₚ, consists of the number of I/O in terms of the I/O types and the data objects. Here, χᵣ^{p}[o] is given as the number of I/Os of type r on object o when the workload is executed over Lₚ. The workload profiles can be calculated either through (a) an estimate computed by our extended query optimizer, or (b) a sample test run of the workload on Lₚ. (

The system can prune the baseline layouts that are being profiled if the query optimizer will choose the same plans on layouts Lₚ and L_{q}, and avoid profiling one of them.

The heuristic step estimates the TOC and then checks the performance constraint for a candidate layout by calling the query optimizer's estimation module to estimate the performance of the workload for that layout. To enable this check, the query optimizer should support, or has to be extended to support: (1) query plan optimization that is aware of the I/O profiles of different storage classes; (2) execution time estimation of the derived query plan.

A typical RDBMS such as PostgreSQL does not consider different I/O performances for heterogeneous storage classes. However, the best query plan can depend on the specific data layout. For example, the choice between a nested-loop join using an index (indexed NLJ) and hash join (HJ) given specific selectivities depends on the random versus the sequential I/O performance characteristics of the different storage classes. In other words, if the system changes the data layout, the cheapest query plan may also change, and the optimizer should be aware of this interaction. To do that, I/O profiles are incorporated into the query plan cost estimation module.

The PostgreSQL optimizer can output a query plan without actually executing the query. This plan includes statistics, such as the query plan cost, the number of I/Os for a scan and the number of rows processed by query operators (e.g., hashing or sorting). These statistics are used to estimate the I/O time associated with executing a query, and use the CPU time estimates already provided by the query optimizer to approximate the query response time as the sum of these two components.

Instead of using the I/O performance numbers of the devices published by the manufacturer or as seen from the OS level, the effective I/O performance of each I/O operation as observed by the DBMS is used, since: (1) with this approach, various overheads (e.g. latch overhead) and benefits (e.g. DB buffers) are incorporated. (2) the influence of concurrent DB queries on I/O performance can be modeled.

To measure the average execution time for each I/O operation, K threads that issue queries over their own tables, i.e., thread i issues a query over table Aᵢ are concurrently run. Each table has a primary key id which is indexed with a B+ Tree.

Read I/O: For read queries, a count(*) query is used to minimize costs associated with producing the output. Each thread issues the following queries:
Sequential Read (SR): To measure the SR performance, each thread issues the following query: select count(*) from Aᵢ.
Random Read (RR): To measure the RR speed, each thread issues a sequence of queries, using the template: select count(*) from Aᵢ where id=?, with randomly selected id values.

The time for each I/O is calculated by dividing the total query execution time to the total number of I/O operation. (In PostgreSQL, these two numbers can be retrieved from the pg_stat catalog.)

Write I/O: Estimating the write I/O performance is more elusive due to optimizations in the OS and the DBMS. (e.g. delayed writes for better performance). Thus, instead of estimating the performance of the I/O operations, we estimated the write performance per row, which is more convenient and robust for the query optimizer to use. The write I/O characteristics is benchmarked as follows:
Sequential Write (SW): The SW performance is measured by having each thread issue a large number of insertion queries, where each query inserts a single row using the template: insert . . . into Aᵢ.
Random Write (RW): To measure the RW performance, each thread issues a sequence of update queries using the template update Aᵢ set a=? where id=? with randomly selected id values. Notice that an update query consists of random read and random write. To estimate RW from update queries, the RR I/O time is subtracted from the execution time.

The time for each write operation (i.e. per row) is calibrated by dividing the total query execution time by the total number of rows affected by the queries.

One challenge to estimate workload performance for each possible layout is interaction between layout optimization and query optimization. An optimal execution plan of a given query can be different depending on a specific layout on heterogeneous storage classes. More specifically, choice between nested-loop join using index (indexed NLJ) and hash join (HJ) given specific selectivity depends on performance ratio between random read and sequential read. The query optimizer 110 is integrated into the layout optimization process in order to handle this interaction.

In one implementation, the query optimizer 110 has two additional capabilities: (1) awareness of different IO characteristics of storage classes, (2) estimation of query execution time. The latter aspect, time estimation, also plays an important role since workload execution time and query response time are involved in our optimization problem.

The validation phase 380 checks if the feasible optimal layout L* really conforms to the performance constraints through a test run of the workload W on L*. As a result, it may turn out that L* does not meet some of the constraints. In such a case, a predetermined margin is added to the constraint value and the optimization process is repeated.

One embodiment employs a heuristic approach to find an optimal layout L* using the IO profiles and time estimation by the query optimizer. Two different types of constraints are handled: performance and capacity. It is desirable to let a heuristic search explore within the space of feasible layouts to minimize the objective function C(W, L). To do this, a layout in the space is needed as a starting point, but such a layout is not trivial: Typically, an expensive storage class performs better but has a tighter capacity limit. Thus, a trivial layout such as placing everything on the most expensive storage class would not be feasible in general.

In one implementation, the heuristic algorithm takes two phases: first, it finds a feasible layout; second, it explores feasible layouts to minimize C(W, L): 1.
Upgrading phase. First, the algorithm starts with the least expensive layout and tries to move objects to more expensive storage classes to find feasible layouts. If there is no feasible layout found, the algorithm returns “infeasible”.
Downgrading phase. Given a feasible layout, the algorithm then tries to offload objects from expensive storage classes to less expensive ones as long as the layout is still feasible and the workload cost C(W, L) decreases.

In the upgrading phase, starting with the least expensive layout, the algorithm moves objects to more expensive storage classes in a greedy manner until the capacity permits. For each move, it checks feasibility of the current layout based on the performance estimation by the query optimizer. If it is feasible, the workload cost C(W, L) is estimated as well. At the end of this greedy movement, a feasible layout with the minimum workload cost is chosen as the input of the next phase.

In one implementation, a PostgreSQL query optimizer is extended to (1) make it aware of heterogeneous storage classes, and (2) estimate execution time. All details of the following modifications and techniques could be generally extended to other open-source DBMSs (e.g. MySQL) equipped with a general query optimizer. In most cases, a query response time is mainly composed of CPU time and I/O time, and PostgreSQL optimizers can output a query plan without executing the query. The query plan often contains much run-time execution information, such as, the number of IO needed for a scan, and the number of rows processed (e.g. hashed or sorted). Based on the information, the system could roughly estimate the I/O time and CPU time without executing a query, and the sum of I/O and CPU times will roughly be the query response time.

Next, one technique to estimate the I/O performance of the storage and CPU time with IO Profiling Table is discussed. The system profiles the following I/O access patterns that are the most commonly seen in DBMS. For example, the following profiles are obtained:

Sequential Read (SR): To get one I/O time of SR, the system runs a sequential scan query against a large table, which should be much larger than DB buffer size. Simultaneously, a timer and counter are used to keep records of the total read I/O time and number of I/O requests issued. (Those could be done by modifying the source code of PostgreSQL.) Then, after that query is finished, the system determines one I/O time of SR by dividing the total read I/O time to the number of I/O requests.

Random Read (RR): To test the time of each RR IO, an index scan is run against a large table. The system sets the index to 100% unclustered and the DB buffer to a minimum value so that the buffer hit ratio is very low, and most pages will be read from disk, instead of from the buffer cache. The timer and counter track the total read I/O time and the number of I/O requests issued. By dividing the total I/O time to the number of I/O request, the system determines one I/O time of RR. That is to say, DBMS issues a write command to operating system and immediately continue to process other requests without waiting for the write to take place. In fact, the real write to disk will not happen until the kernel feels it is needed. Thus, on occasions, the RR IO approximates but is not the “real” I/O time.

Raw Random Update (RRU): Since the method of profiling the read I/O cannot measure the time of randomly updating a record, the system tests the response time of continuously updating a larger number of records in a large table, and the records should have an index (e.g B-tree) on the primary key attribute (e.g. record ID). When profiling, the system randomly generates a value of the primary key attribute, then use the index to find that record and update some attribute values. As implemented in the PostgreSQL, a Complete Random Update (CRU) involves two operations: (1) perform random reads for reading the index and data into the DB buffers; and (2) apply the updates, write back to the DB buffers and commit the updates. Since the total response time of continuously updating a number of records is the performance of Complete RU, for profiling the Raw RU, the system subtracts the random read time from the total response time, and gets the I/O time of Raw RU for one record by dividing the time for Raw RU to the number of updates. Next, the Insert performance on different storage devices is considered. In real OLTP workloads, Insert operations are always mixed with other queries and due to the high concurrency of data access, Insert operations are no longer be a sequential I/O pattern and looks more similar with the Raw Random Update operation discussed above. Therefore, the I/O performance of Raw Random Update is used to model the Insert performance.

The above three profiling steps are done for each available disk to get a I/O profiling. The numbers in profiling table may not be able to exactly reflect the real I/O performances. However, the real purpose of the I/O profiling table is to tell the query optimizer, when it computes the cost of the query plans, to use different I/O times for the objects storing in different disks.

Next, CPU time estimates are determined. The CPU time is difficult to capture during a query execution. Fortunately, PostgreSQL generally classifies the CPU cost into 3 categories: cpu tuple cost, cpu index tuple cost and cpu operator cost. The query optimizer in PostgreSQL actually uses those three parameters to estimate the CPU cost. However, the default values of those parameters are not good in most cases and should be tuned for a particular CPU. One method to find the “reasonable” values of those parameters to approximately give an estimate of how long the CPU time will take in a query execution is discussed next. The system uses the same query (“select count(*) from table”) previously used for profiling the Sequential Read. After executing that query, the total response time and read I/O time are obtained. The CPU time could be computed by subtracting the read I/O time from the total response time, and the value for cpu tuple cost could be set by dividing the CPU time to the number of records in that table. The reason why the same query is used to set the value of cpu tuple cost is: “count(*)” will almost eliminate the output time in the total response time, which will make the CPU time more precise to be observed. For remaining two CPU time parameters, cpu index tuple cost and cpu operator cost, a “Rule of thumb” is used which gives the general ratio between cpu tuple cost and cpu index tuple cost, and between cpu tuple cost and cpu operator cost.

The above system provides an efficient data layout optimization framework for heterogeneous storage environments to reduce the cost of running query workloads with performance guarantee. A prototype of a data layout optimization system has been built on top of PostgreSQL. The system uses an SSD-aware time-based query optimizer, which estimates the response time of a query for a specific data layout. The system employs a heuristic that utilizes the information from this query optimizer to recommend a data layout that gives the minimum cost of running workloads under performance guarantee constraints. The system quickly determines a cost-effective data layout that minimizes the cost of running a workload while guaranteeing the SLAs and capacity constraints. The SSDaware Time-based query optimizer is a modified PostgreSQL optimizer. The query optimizer can detect the interaction between the query plans and underlying data layout and dynamically update the cheapest query plan and response time of a query based on the changing data layout. A heuristic is used that could utilize the query estimates from the backend to find a cost-effective data layout while the capacity and SLAs constraints are guaranteed.

Through extensive experiments, the effectiveness and efficiency of the system have been verified by OLAP and OLTP workloads. One implementation with PostgreSQL and various workloads demonstrates that the efficacy of the above methods. To illustrate, for TPC-H workloads, the advised data placements could save 3×-6× on TOO, compared to the data placement with the fastest response time, and still guarantee over 95% SLAs. For TPC-C workloads, the advised data placements only use 30% TOO to achieve 90% of TpmC of the data placement with the fastest response time.

The techniques could be extended to other DBMS equipped with a standard query optimizer. Additionally, the techniques discussed above are not specific to any SSD products but provides a general framework to cover any storage devices, including future storage technology. The system only requires a set of IO performance metrics, which is defined as an IO profiling table. The framework can incorporate any upcoming storage devices or change in price or performance of the existing devices.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

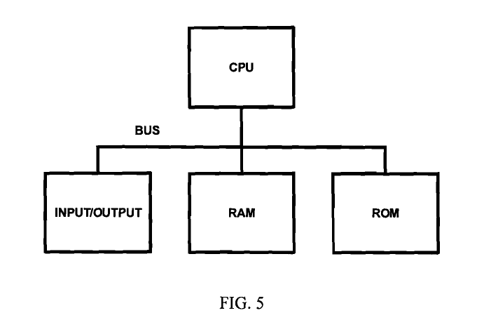

By way of example, a block diagram of a computer to support the system is discussed next in FIG. 5. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The system has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A system to optimize layout of database objects in a relational database management system stored on a plurality of storage classes each characterized by a price and a storage capacity, comprising:
a time-based query optimizer to estimate an execution time of a query workload on a data layout for the plurality of storage classes; and
a layout recommender coupled to the time-based query optimizer to estimate the TCO for the query workload on each data layout, wherein the layout recommender determines an optimal data layout that minimizes a total cost of operation (TCO) for the storage classes.

2. The system of 1, where a device TCO profile comprises an amortized cost of the device.

3. The system of 1, wherein the query optimizer operates on one or more database objects.

4. The system of 3, wherein the database objects comprises tables and indexes.

5. The system of 1, wherein the layout recommender receives a device profile including random input/output (I/O) performance and sequential I/O performance.

6. The system of 1, wherein the layout recommender conforms to one or more performance constraints.

7. The system of 1, wherein the layout recommender receives workload information and device information.

8. The system of 7, wherein the workload information comprises database and queries and the device information comprises I/O profile and TCO profile.

9. The system of claim 1, wherein the plurality of storage classes comprise at least a hard disk device (HDD), a first solid state disk (SSD), and a second SSD, wherein the first SSD is faster than the second SSD.

10. The system of claim 1, wherein the layout recommender receives input data on database objects O={o₁, . . . , o_{N}}, storage classes D={d₁, . . . , d_{M}} with price P={p₁, . . . , p_{M}} and capacity C={c₁, . . . , c_{M}}, query workload W={[q₁¹, . . . , qₙ¹], . . . , [q₁^{c}, . . . , qₙ^{c}]} with performance constraints T={tᵢ^{j}}.

11. The system of claim 10, wherein the layout recommender generates the data layout L:O→D that minimizes the TOC.

12. The system of claim 11, wherein C(L,W)=C(L)*t(L,W) for a given W, where
C(L)=p₁*(Σₒ_{ᵢ}_{εO}_{₁}sᵢ)+ . . . +p_{M}*(Σₒ_{ᵢ}_{εO}_{_{M}}sᵢ)
under capacity constraints, Σₒ_{ᵢ}_{εO}_{ⱼ}sᵢ<cⱼ (j=1, . . . , M), and performance constraints T={tᵢ^{j}}.

13. A method to optimize layout of database objects in a relational database management system stored on a plurality of storage classes, each characterized by a price and a storage capacity, comprising:
estimating with a time-based query optimizer an execution time of a workload on a data layout for the plurality of storage classes; and
recommending a data layout for the plurality of storage classes to minimize a total cost of operation (TCO) for the storage classes.

14. The method of 13, where a device TCO profile comprises an amortized cost of the device.

15. The method of 13, wherein the query optimizer operates on one or more database objects including tables and indexes.

16. The method of 15, wherein the layout recommender receives a device profile including random input/output (I/O) performance and sequential I/O performance.

17. The method of 13, wherein the layout recommender conforms to one or more performance constraints.

18. The system of 13, wherein the layout recommender receives workload information and device information and wherein the workload information comprises database and queries and the device information comprises I/O profile and TCO profile.

19. The method of claim 13, comprising implementing the data layout over a hard disk device (HDD), a first solid state disk (SSD), and a second SSD, wherein the first SSD is faster than the second SSD.

20. The method of claim 13, comprising:
receiving input data on database objects O={o₁, . . . , o_{N}}, storage classes D={d₁, . . . , d_{M}} with price P={p₁, . . . , p_{M}} and capacity C={c₁, . . . , c_{M}}, query workload W={[q₁¹, . . . , qₙ¹], . . . , [q₁^{c}, . . . , qₙ^{c}]} with performance constraints T={tᵢ^{j}}, and
generating the data layout L:O→D that minimizes the TOC, wherein C(L,W)=C(L)*t(L,W) for a given W, and where C(L)=p₁*(Σₒ_{ᵢ}_{εO}_{₁}sᵢ)+ . . . +p_{M}*(Σₒ_{ᵢ}_{εO}_{_{M}}sᵢ) under capacity constraints, Σₒ_{ᵢ}_{εO}_{ⱼ}sᵢ<cⱼ (j=1, . . . , M), and performance constraints T={tᵢ^{j}}.
